(19) United States
(12) Patent Application Publication
(10) Pub. No.: US 2023/0146867 A1
(43) Pub. Date: May 11, 2023

(54) LIFTING DEVICE FOR THE RAIL-GUIDED TRANSPORTATION OF A VEHICLE

(71) Applicant: Michael Traut, Bergrheinfeld (DE)

(72) Inventor: Michael Traut, Bergrheinfeld (DE)

(21) Appl. No.: 17/918,754

(22) PCT Filed: Apr. 8, 2021
(86) PCT No.: PCT/EP2021/059162

§ 371 Date: Oct. 13, 2022

(30) Foreign Application Priority Data
Apr. 15, 2020 (DE) 10 2020 110 268.2

(51) Int. Cl. B60S 9/205

(52) U.S. Cl. CPC B60S 9/205

(57) ABSTRACT

A lifting device for the transportation of a vehicle comprising a support structure which is suitable for connection to the vehicle and comprising at least one lifting unit to lift the vehicle from a lowered vehicle position on a ground surface, into a completely or partially lifted vehicle position. The aim of the present invention is to free a heavy vehicle from an immobilized state, to overcome obstacles and to further increase maneuverability overall. The support structure has guide rails which are connected to the vehicle, and guide rods which are connected to at least one lifting unit and are guided linearly in the guide rails so that, in the lifted vehicle position, the guide rails, together with the vehicle, can be moved relative to the ground and, in the lowered vehicle position, the guide rods, together with the lifting unit, can be moved linearly relative to the ground surface.

### BACKGROUND OF THE INVENTION

The invention relates to a lifting device for the transportation of a vehicle, in particular of a trailer and/or motor vehicle, comprising a support structure which is suitable for releasable or firm connection to the vehicle, in particular to a vehicle underbody of the vehicle, and comprising at least one lifting unit which is provided to lift the vehicle in a lifting direction from a lowered vehicle position, in which the vehicle rests on a ground surface, into a completely or partially lifted vehicle position.

The invention also relates to a vehicle, in particular to a motor vehicle or a trailer, having a lifting device according to the invention as well as to a method for the transportation of a vehicle by means of such a lifting device.

The term vehicle below is understood to mean all self-driven vehicles, in particular motor vehicles such as passenger cars, trucks, tracked vehicles or other commercial vehicles, but also to any designs of trailers which do not have a separate drive.

Vehicles, i.e., motor vehicles or trailers, are used not only in road traffic but also off-road, in open, sometimes rough terrains, for the transport of vehicle occupants and/or goods, but also for construction or rescue work and/or for surveying of the terrain. When driving off-road, it can happen that the wheels, chains or other drive means which are usually provided for the transportation of the vehicle, for example, on a muddy or sandy ground surface, but also on ice or snow, spin due to lack of traction and can no longer transport the vehicle. It is precisely in the case of sand or mud that it can moreover happen that the wheels of the vehicle dig in, which also results in transportation no longer being possible. Another challenge when driving off-road consists in overcoming obstacles, for example, an elevation or a ledge. Depending on the height of the obstacle, driving across the obstacle is not at all possible using the conventional wheel drive, or, when an attempt to drive across is made, the vehicle underbody may bottom out, whereby the vehicle becomes stuck on the obstacle and can no longer be transported.

For example, from DE 26 06 399 A1, an all-terrain vehicle is known, on the bottom underside of which, that is to say on the vehicle underbody, hydraulic cylinders designed as lifting cylinders are pivotably arranged, the bearing axles of which extend transversely to the vehicle longitudinal direction. By means of the hydraulic cylinders attached on the vehicle, transportation, supporting and lifting of the vehicle are to be enabled. The control of the lifting cylinder can take place automatically or manually from the vehicle interior. However, using the described device, an actual or complete lifting of the all-terrain vehicle is not possible, as a result of which it is impossible to overcome obstacles. For transportation, the wheels must still rest on the ground surface and actually roll. The lifting cylinder is used only for pushing the vehicle, as a result of which a lateral transportation can also not be implemented.

A supporting steering device and a walking device for a vehicle are known from CN 103 434 498. The supporting steering device comprises a hydraulic cylinder which is pivotably connected at its lower end to a bottom plate for resting on the ground surface and at its upper end to a rotating plate arranged on the motor vehicle. Thereby, the supporting steering device, if it is not in use, can be brought in contact with the vehicle underbody, and, if necessary, it can be pivoted out, wherein the motor vehicle is lifted into a lifted position in which all four wheels lose contact with the ground surface. Subsequently, the vehicle can be rotated 180° by means of the rotating plate, for example, to perform a “U-turn.” In addition, the motor vehicle is provided with a running device which includes four separate “feet” which are supposed to enable a running movement due to the pivoting of multiple plates and arms about respective pivot axles connecting said plates and arms to one another. On the one hand, such a “walking” transportation is complicated in terms of control technology and nearly impossible to perform on an uneven or slippery ground surface. In addition, such transportation also leads to intense rocking of the motor vehicle, which decreases the comfort for the vehicle occupants.

Overall, the devices disclosed in the prior art are often not very reliable in use or implemented in a complicated and expensive manner, whereby in particular the only limited existing installation space on the vehicle underbody is completely occupied and/or the ground clearance is considerably influenced. In addition, the described devices are also not suitable for the transportation of heavy motor vehicles having a total weight of more than several tons, such as, for example, trucks, since the movable components, in particular the deployable or pivotable components, are not suitable for accommodating the transverse forces and bending moments occurring here.

Therefore, the aim of the present invention is to eliminate the disadvantages from the prior art and to create a lifting device for the transportation of a vehicle, in particular of a trailer or of motor vehicle, which in particular makes it also possible to free a heavy vehicle, in particular a heavy trailer or a heavy motor vehicle having a weight of at least several tons, such as, for example, trucks, all-terrain vehicles, tracked vehicles or other commercial vehicles or trailers, from an immobilized state, to overcome obstacles and to further increase the maneuverability overall.

### SUMMARY OF THE INVENTION

The aim is achieved by a lifting device according to claim 1, by a vehicle having a lifting device according to claim 12, and by a method according to claim 15.

A lifting device according to the invention of the type described in further detail at the beginning is characterized in that the support structure comprises one or more guide rails as well as one or more guide rods which are guided linearly in the guide rails, wherein the guide rails are indirectly or directly connected to the vehicle and the guide rods are indirectly or directly connected to at least one lifting unit, so that, in the lifted vehicle position, the guide rails, together with the vehicle, can be moved linearly relative to the ground surface, in particular in the vehicle longitudinal direction x and/or in the vehicle longitudinal direction y, and, in the lowered vehicle position, the guide rods, together with the at least one lifting unit, can be moved linearly relative to the ground surface, in particular in the vehicle longitudinal direction x and/or in the vehicle transverse direction y.

However, alternatively, according to the invention, the guide rods can also be indirectly or directly connected to the vehicle, and the guide rails can be indirectly or directly connected to at least one lifting unit, so that, in the lifted vehicle position, the guide rods, together with a vehicle, can be moved linearly relative the ground surface, in particular in the vehicle longitudinal direction x and/or in the vehicle transverse direction y, and, in the lowered vehicle position, the guide rails, together with the at least one lifting unit, can be moved linearly relative to the ground surface, in particular in the vehicle longitudinal direction x and/or in the vehicle transverse direction y.

Thus, according to the invention, a lifting device is provided, which comprises at least one lifting unit and a support structure, wherein the support structure includes one or more guide rails and guide rods guided therein. Only the guide rails (or alternatively the guide rods) are connected to the vehicle itself, preferably to its underbody or to another supporting component of the vehicle. This connection can be implemented as firm or else releasable to enable subsequent retrofitting of a vehicle or, if necessary, assembly and disassembly also in the case of repair. Likewise, an indirect connection via adapter pieces is possible.

The at least one lifting unit, which is driven, for example, via one or more linear actuator(s) such as hydraulic or pneumatic cylinders, electrically deployable actuators or other linear actuator principles known from the prior art, makes it possible for the vehicle to be lifted from its lowered position with its wheels, chains or other drive means on the ground surface into a completely lifted vehicle position (also operating position) in which the wheels, chains or other drive means are not in contact with the ground surface or into a partially lifted vehicle position in which a portion of the wheels, chains or other drive means is not in contact with the ground surface and for the vehicle to be put down again. For the transportation of the vehicle, the at least one lifting unit is connected to one or more guide rods (or alternatively guide rails) of the support structure. The guide rods are guided in the guide rails and, together with the at least one lifting unit, can be moved relative to the guide rails and consequently also relative the vehicle. Depending on the orientation of the support structure, a linear displacement of the lifting unit relative to the vehicle in a direction in a plane parallel to the underbody, in particular in the vehicle longitudinal direction x and/or the vehicle transverse direction y, is enabled.

According to the invention, in the lifted vehicle position, a relative movement between guide rail and guide rod leads to a displacement of the guide rail with the vehicle attached thereto with respect to the ground surface, while the lifting unit supported on the ground surface as well as the guide rod itself remain stationary in their original position. Vice versa, in the lowered vehicle position, in which the vehicle rests on the ground surface, a relative movement between guide rail and guide rod leads to a displacement of the guide rod, together with the lifting unit attached thereto, with respect to the ground surface, while the vehicle, together with the guide rail, remains stationary in its original position.

In this way, a vehicle can be transported by repeated lifting, displacement, lowering, without the need to use the separate drive of the vehicle. Advantageously, the vehicle can thus be freed from an “immobilized” position and/or moved over obstacles. Likewise advantageously, the implementation of the lifting device by guide rods guided in guide rails enables a particularly stable design, whereby the absorption of high transverse forces and/or high bending moments is enabled, so that particularly heavy vehicles having a weight of at least several tons, such as, for example, trucks, all-terrain vehicles, tracked vehicles or other commercial vehicles or trailers, can also be lifted and transported.

Advantageous embodiments are claimed in the dependent claims and explained in further detail below.

Thus, the lifting device can comprise one or more guide rails and one or guide rods which are oriented parallel to the vehicle longitudinal direction x and/or parallel to the vehicle transverse direction y, so that the guide rods are guided in the guide rails linearly in the vehicle longitudinal direction x and/or linearly in the vehicle transverse direction y.

Preferably, multiple, in particular two, guide rails with guide rods guided therein are indirectly or directly connected to the vehicle parallel to the vehicle longitudinal direction x and parallel to one another, so that it is possible to transport the vehicle in the vehicle longitudinal direction x, forward or backward as desired. Additionally or alternatively, multiple, in particular two, guide rails with guide rods guided therein can be indirectly or directly connected to the vehicle parallel to the vehicle transverse direction y and parallel to one another, in order to be able to laterally transport the vehicle in the vehicle transverse direction y.

In order to further increase the stability, it is also advantageous if, according to an embodiment, the support structure comprises at least two guide rails oriented parallel to one another with respective guide rods guided therein, wherein the guide rails are connected to one another via a rail connection piece and the guide rods are connected to one another via a rod connection piece to form a linearly extendible frame structure, and wherein the rail connection piece can be moved relative to the rod connection piece.

Due to the fact that two guide rails and two guide rods guided therein are each connected to one another via a rail connection piece or a rod connection piece in the manner of a frame, the ability of the support structure to absorb transverse forces and/or bending moments is further increased. The guide rods connected to one another via the rod connection piece can be deployed “in the manner of drawers” by means of linear actuators preferably located in between, which are designed, for example, as hydraulic or pneumatic cylinders, or are electrically driven.

Furthermore, it is advantageous for the operation if the guide rods are arranged within the guide rails and if at least two inner walls of the guide rails are designed as supporting or sliding surfaces on which the guide rods are supported when subjected to corresponding forces.

For example, the guide rods can be designed as completely closed or partially open pipes or supports having a rectangular, round or other suitable cross section. The guide rods guided in the interior of the guide rails have a complementary cross section and, depending on the direction of the acting forces and/or moments, they are supported on the corresponding inner walls of the guide rails. To the extent that the support structure, for example, in the lowered vehicle position, “hangs” under the vehicle, the weight of the lifting unit acts in the direction of the ground surface, while, in the lifted vehicle position, the weight of the vehicle itself acts in the direction of the ground surface. The guide rods can be supported on the upper and lower inner walls of the guide rails. The inner walls of the guide rails, which in the operating position of the vehicle are temporarily oriented, specifically parallel to the vehicle vertical axis z, laterally support the guide rods and thus prevent a tilting of the guide rods in the guide rails. At the same time, the inner walls of the guide rails are also used as sliding surfaces on which the guide rods slide when deployed or retracted.

As a rule, the at least one lifting unit is arranged under the support structure with respect to the vehicle vertical axis z. However, to save ground clearance, an advantageous embodiment provides that, with respect to the vehicle longitudinal direction x, at least one lifting unit is oriented longitudinally with respect to the vehicle support structure and is connected to one or more guide rods in such a way that the support structure and the at least one lifting unit are arranged in a common plane, wherein the lifting unit extends either between mutually adjacent guide rails or is arranged longitudinally with respect to one or more guide rods.

Due to the fact that the lifting units are arranged in a plane with the support structure, before or after or in between or next to the support structure, the overall extension of the lifting device in the vehicle vertical axis z can be reduced, for example, in order to enable an attachment on vehicles with only little ground clearance.

It is possible that one or more lifting units are arranged exclusively on a vehicle longitudinal side or vehicle transverse side, wherein the vehicle can then be moved along the lifting direction h from the lowered vehicle position into an only partially lifted vehicle position.

Due to the fact that only a portion of the vehicle is lifted and the other portion, in particular the front or rear wheels, chains or other drive means, continue to rest on the ground surface, the vehicle can be transported in the manner of a wheelbarrow by deployment of the guide rods, wherein the lifting unit is supported on one vehicle side on the ground surface, and, on the respective other vehicle side, the rails, chains or other drive means resting on the ground surface roll or slide on the ground surface. With this embodiment variant, heavier loads can be lifted and/or transported, since both the support structure and also the lifting unit support only a portion of the vehicle weight.

Precisely in combination with the above-described embodiment variant, the connection of the at least one lifting unit to one or more guide rods or to one or more guide rails is advantageously designed to be fixed, so that the lifting direction h is always oriented substantially parallel to the vehicle vertical axis z.

When the vehicle is lifted on only one vehicle longitudinal side, for example, the front or rear vehicle longitudinal side, a rotation or a pivoting of the vehicle about a transverse axis arranged on the opposite vehicle longitudinal side takes place, and the vehicle is set up at a slant or tilted. By a rigid or fixed connection of the lifting unit to the support structure, more precisely to the guide rods, the lifting direction h which is directed orthogonally to the ground surface at the beginning also “rotates” and always extends parallel to the vehicle vertical axis z, and the vehicle is lifted by translation. Such a design further increases the stability of the overall system.

During travel, in order not to affect the normal vehicle operation, according to an alternative design of the invention, the connection of the at least one lifting unit to one or more guide rods or to one or more guide rails can be implemented by means of an articulation, so that the at least one lifting unit can be pivoted and/or rotated between a transport position and an operating position.

In this design, the at least one lifting unit and the guide rods or the guide rails can additionally be connected to one another via one or more pivot cylinders. By actuation of the pivot cylinders, the at least one lifting unit can be pivoted out of the transport position, in which the at least one lifting unit is arranged, for example, in the interior, in the storage space and/or on a loading surface of the vehicle, into the operating position, in which the at least one lifting unit is oriented for lifting and lowering the vehicle, or said lifting unit can be pivoted out of the operating position into the transport position. Depending on the predetermined space conditions, it can be advantageous that the articulation axis extends along or parallel to the guide rails or guide rods or is oriented transversely or orthogonally thereto.

A particularly compact or space-saving transport position, whereby, for example, the arrangement of the lifting device during normal vehicle operation in a passenger car trunk space is enabled, can be implemented according to an optional variant of the invention, in that one or more components of the at least one lifting unit and/or of the support structure, in particular lifting cylinders, lifting guides, guide rails, guide rods, linear rail actuators and/or pivot cylinders, are telescopically designed, so that the at least one lifting unit can be moved linearly between the transport position and an operating position and/or the vehicle in the lifted vehicle position can be moved linearly relative to the ground surface.

Thus, in particular a telescopic design of the guide rails and/or of the guide rods contributes not only to the facilitated transport of the lifting device but also to the transportation of the vehicle. By a telescopic design of the lifting units, additional space can be saved in the transport position. In combination with a design in which the at least one lifting unit is connected to one or more guide rods or to one or more guide rails by means of an articulation, the at least one lifting unit can thus be first linearly deployed, for example, from a transport position, and subsequently pivoted about the articulation axis into the operating position.

According to an advantageous variant of the invention, in order to achieve additional stability, the at least one lifting unit comprises a stopping means which stops the at least one lifting unit in a retracted, completely deployed or partially deployed position.

In the case of particularly heavy loads, when the vehicle is displaced by means of the support structure, very high forces act on the completely or partially deployed lifting unit. To be able to reduce the load on the lifting unit, said lifting unit can be designed with a stopping means, for example, a toothing, which, if necessary, stops the lifting unit in the desired deployed position.

Finally, it is also advantageous if the support structure is designed for indirect or direct attachment to one or more longitudinal and/or cross members of the vehicle underbody of the vehicle, wherein at least one wall of the longitudinal and/or cross member connected to the support structure is designed as supporting or sliding surface on which the guide rods of the support structure are supported when subjected to corresponding forces.

In this design, the load-bearing capacity of the vehicle underbody, in particular of the longitudinal and/or cross members there, of the vehicle to be transported itself is to be used. For this purpose, a wall of a longitudinal and/or cross member oriented downward with respect to the vehicle vertical axis z, in the direction of the ground surface, can replace an inner wall of a guide rail as supporting and/or sliding surface. In this case, the guide rail is partially open, designed, for example, as a U-profile. In particular, this embodiment variant is suitable for forming the device with a lower overall weight, in order not to exceed, for example, acceptable loads of the vehicle.

The invention therefore also relates to a vehicle, in particular to a motor vehicle or to a trailer, having a lifting device according to one of the above-described embodiment variants, wherein the one or more guide rails of the support structure are indirectly or directly connected firmly or releasably to the vehicle, wherein an attachment on the vehicle underbody and/or on the vehicle roof and/or to a vehicle loading surface and/or on the vehicle frame and/or on the vehicle body takes place.

Preferably, the lifting device is connected firmly or releasably to supporting components of the vehicle, although it can nonetheless be positioned in the desired position, in particular under the vehicle. Individual components of the device, in particular drive elements and/or fuel tanks but also an associated open-loop and/or closed-loop control device can also be accommodated within a storage space, a passenger compartment or on a loading surface of the vehicle.

In an advantageous embodiment, the one or more guide rails of the support structure are attached to one or more longitudinal members and/or cross members of the vehicle underbody of the vehicle, wherein at least one wall of the longitudinal member and/or cross member connected to the support structure is designed as supporting or sliding surface on which the guide rods of the support structure are supported when subjected to corresponding forces.

In the case in which the longitudinal members and/or cross members do not comprise a flat extending sliding surface along which the guide rods can slide, an adapter structure can advantageously be provided, which is arranged between the longitudinal members and/or cross members and the guide rods or the guide rails. The side of the adapter structure facing the guide rods or the guide rails preferably comprises a straight and flat sliding surface; the remaining sides can be supported on the longitudinal members and/or cross members and are advantageously designed to be complementary to their course.

In order not to affect the normal vehicle operation, it is advantageous that the at least one lifting unit in a transport position is arranged in a storage space and/or on a loading surface and/or on the roof and/or on the engine hood and/or on the trunk lid of the vehicle and/or on the vehicle front and/or on the vehicle rear and/or laterally on the vehicle.

In a development, the at least one lifting unit can be moved and/or pivoted by means of the support structure between the transport position and an operating position for the transportation of the vehicle, wherein one or more components of the at least one lifting unit and/or of the support structure are telescopically designed and/or the at least one lifting unit is pivotably or rotatably connected via an articulation to the support structure. In an arrangement of the at least one lifting unit on the vehicle front and/or on the vehicle rear, the articulation makes it possible to pivot the at least one lifting unit in in the transport position in order to avoid obstruction of the view.

Finally, the aim of the invention formulated at the beginning is also achieved by a method for the transportation of a vehicle, in particular of a motor vehicle or trailer, by means of a lifting device according to one of the above-described embodiments.

Here, the vehicle is lifted by means of at least one lifting unit of the lifting device in a lifting direction from a lowered vehicle position, in which the vehicle rests on the ground surface, into a completely or partially lifted vehicle position, is displaced in the lifted vehicle position relative to the ground surface by means of mutually movable guide rails and guide rods of a support structure of the lifting device, and is lowered from the completely or partially lifted vehicle position into the lowered vehicle position by means of the at least one lifting unit of the lifting device.

Optionally, the at least one lifting unit can be deployed by means of the support structure from a transport position into an operating position and/or be pivoted out of the transport position into the operating position by means of an articulation connecting the at least one lifting unit and the support structure. After the transportation of the vehicle has taken place, the at least one lifting unit can naturally be correspondingly pivoted in and/or retracted from the operating position into the transport position.

Additional details, features, (sub) combinations of features, advantages and effects on the basis of the invention result from the following description of preferred embodiment examples of the invention and the drawings.

### BRIEF DESCRIPTION OF THE SEVERAL VIEWS OF THE DRAWINGS

FIG. 1 is a diagrammatic perspective representation of a first exemplary embodiment of the lifting device according to the invention with two guide rails, two guide rods and two lifting units in a completely retracted position,

FIG. 2 is a diagrammatic perspective representation of the first embodiment of FIG. 1 with the guide rails and guide rods as well as the lifting units in a completely deployed position,

FIG. 2a is a diagrammatic perspective representation of an exemplary stopping means which is provided as optional component of the lifting unit according to FIGS. 1 and 2,

FIG. 2b is a diagrammatic perspective representation of an enlarged detail of the stopping means of FIG. 2a,

FIG. 3 is a diagrammatic sketch of an exemplary movement course of the lifting device for the transportation of a vehicle,

FIG. 4 is a diagrammatic perspective representation of a second exemplary embodiment of the lifting device according to the invention, wherein the lifting unit is arranged between every two adjacent guide rails,

FIG. 5 is a diagrammatic perspective representation of a third exemplary embodiment of the lifting device according to the invention for the transportation of a vehicle in a vehicle longitudinal direction and in a vehicle transverse direction,

FIG. 6 is a diagrammatic perspective representation of a fourth exemplary embodiment of the lifting device according to the invention having a total of four lifting units for completely lifting a vehicle as well as for the transportation of the vehicle in a vehicle longitudinal direction and in a vehicle transverse direction,

FIG. 7 is a diagrammatic perspective representation of a fifth exemplary embodiment of the lifting device according to the invention, wherein the support structure is attached to transverse and longitudinal members of the vehicle,

FIG. 7a is a diagrammatic partial section of an exemplary embodiment of an adapter piece,

FIG. 8 is a diagrammatic perspective representation of a sixth exemplary embodiment of the lifting device according to the invention, which is attached to a trailer,

FIG. 9 is a diagrammatic perspective representation of a first embodiment of a traction foot on a lower section of a lifting unit,

FIG. 10 is a diagrammatic perspective representation of a second embodiment of a traction foot on a lower section of a lifting unit,

FIG. 11 is a diagrammatic perspective representation of a third embodiment of a traction foot on a lower section of a lifting unit,

FIG. 12 is a diagrammatic perspective representation of a seventh exemplary embodiment of the lifting device according to the invention with two vertical lifting units,

FIG. 13 a is diagrammatic perspective representation of an eighth exemplary embodiment of the lifting device according to the invention with two vertical lifting units which can be pivoted and/or rotated about respective articulation axes,

FIG. 14 is a diagrammatic perspective representation of a ninth exemplary embodiment of the lifting device according to the invention with two pivotable and/or rotatable vertical lifting units, wherein respective articulation axes are oriented parallel to the support structure, and in

FIG. 15 is a diagrammatic perspective representation of a tenth exemplary embodiment of the lifting device according to the invention in a transport position.

The figures are merely exemplary in nature and used only for the understanding of the invention. Identical elements are always provided with identical reference numerals, and for this reason, as a rule, they are also described only once. The represented embodiment variants are mostly symmetrical with respect to their longitudinal axis and partially symmetrical with respect to their transverse axis. For clarity, elements which are mirrored on these axes in the figures are always marked only once with a reference numeral.

### DETAILED DESCRIPTION OF THE INVENTION

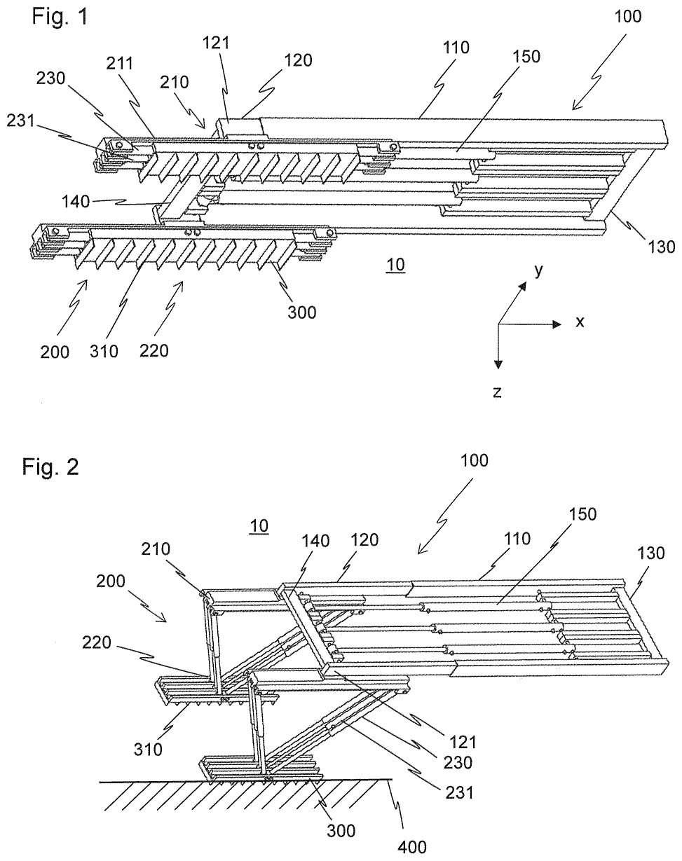

In FIG. 1, a diagrammatic perspective representation of a first exemplary embodiment of the lifting device 10 according to the invention, having a support structure 100 and two lifting units 200, is shown. The representation shows the lifting device 10 from below, i.e., looking from the ground surface 400 in the direction of the vehicle underbody. The two lifting units 200 are here associated with the same vehicle longitudinal side. Both the support structure 100 and also the lifting units 200 are in a completely retracted position. The support structure 100 comprises two guide rails 110 running parallel, which are connected to one another at a mutual distance to one another via a rail connection piece 130. In the guide rails 110, designed here as rectangular pipes, in each case a guide rod 120 comprising a complementary cross section and here also rectangular cross section is movably mounted. The guide rods 120 are connected to one another at a mutual distance in the region of a connection section 121 (also in the completely retracted position) protruding from the guide rails 110 via a rod connection piece 140, so that the support structure 100 overall is designed in the manner of a frame. Preferably, the guide rails 110 are oriented in the vehicle longitudinal direction x of the vehicle 500 and attached to the vehicle 500, in particular to its underbody and/or preferably to a supporting component of the vehicle 500, so that the connection sites between guide rails 110 and vehicle 500 can support the portion of the vehicle weight taken up by the guide rails 110. If no supporting component of the vehicle 500 is available at the connection sites of the guide rails 110, the guide rails 110 can be connected to a support adapter (not represented) which is part of the lifting device 10.

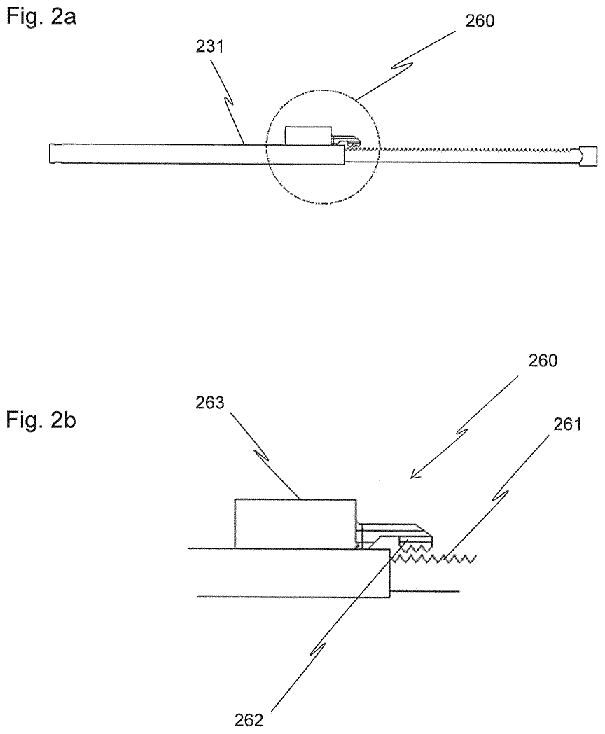

Between the guide rails 110 and oriented parallel thereto at least one linear rail actuator is provided, in the exemplary embodiment variant three linear rail actuators 150 being provided, one end of which is supported on the rail connection piece 130 and the other end of which is supported on the rod connection piece 140. The linear rail actuators 150 can be designed, for example, as hydraulic cylinders, pneumatic cylinders, electrolinear units, etc., and they are preferably actuated by the operator or by an open-loop and/or closed-loop control unit in order to move the support structure 100 from the completely retracted position shown here into a partially or completely deployed position (see FIG. 2).

On the respective connection section 121 of the guide rods 120, in each case a lifting unit 200 is arranged, which is provided for lifting and lowering the vehicle 500 from a lowered vehicle position into a lifted vehicle position and vice versa. The lifting unit 200 substantially includes a lifting support 211 which is arranged on an upper section 210 of the lifting unit 200, which faces the vehicle 500, as well as a pivotable articulated traction foot 300 which is arranged on a lower section 220 of the lifting unit 200, which faces the ground surface 400. For deploying the lifting unit 200, one or more linear actuators 230 are supported on the lifting support 211 and on the traction foot 300. In the representation shown here, in each case two external linear actuators 230 are pivotably attached to the two longitudinal-side ends of the lifting support 211 and they are guided in each case by a linear guide 231 lying in between. The linear guides 231 are used for absorbing transverse forces and/or bending moments which could and can damage the linear actuators 230, and, like the guide rails 110 as well, can have different cross-sectional shapes, in particular a rectangular, circular, oval, T-shaped, U-shaped, double T-shaped, cross-sectional shape, etc. In the lower section 220 of the lifting unit 200, the traction foot 300 is pivotably articulated to the linear actuators 230, in order to be able to compensate for irregularities and/or gradients of the ground surface 400. In order to increase the friction between ground surface 400 and traction foot 300, the latter has a traction profile 310. In the completely retracted position of the lifting unit 200 shown here, lifting support 211, linear actuators 230 as well as traction foot 300 are oriented parallel to the guide rails 110 and to the guide rods 120 of the support structure 100, whereby the necessary installation space is reduced, in particular under the vehicle 500.

FIG. 2 shows a diagrammatic perspective representation of the first embodiment of FIG. 1, viewed from the top, i.e., from the direction of the vehicle 500 in the direction of the ground surface 400. Both the support structure 100 and also the two lifting units 200 are here shown in a completely deployed position. Since in this embodiment the two lifting units 200 are provided on only one vehicle longitudinal side, the vehicle 500, which is not represented, is in a partially lifted vehicle position, i.e., in particular the wheels, chains or other drive means of the vehicle 500 arranged on one longitudinal side “hang in the air,” while the wheels, chains or other drive means of the vehicle 500 arranged on the other longitudinal side, continue to rest on the ground surface 400. The lifting direction h itself extends orthogonally with respect to the lifting support 211 and parallel to the vehicle vertical axis z.

FIGS. 2a and 2b each show a diagrammatic perspective representation of an exemplary stopping means 260 which is provided as optional component of the lifting unit 200 according to FIGS. 1 and 2, wherein FIG. 2b represents an enlarged detail of FIG. 2a.

In order to completely stop the lifting unit 200 in a completely or partially deployed position, the linear guide 231 arranged between the linear actuators 230 can be designed with a stopping means 260. The stopping means 260 is designed here, for example, as toothing 261 which extends along a guide rod of the linear guide 231. A tooth anchor 262 having a counter-toothing designed to complementarily fit the toothing 261 is connected to the guide rail of the linear guide 231. In order to move the tooth anchor 262 into a position engaging in the toothing 261 and thus be able to stop the lifting unit 200 in the desired deployed position, if necessary, an actuator 263 or an electromagnet is connected to the tooth anchor 262 in order to pivot and/or to perform linear movements. Alternatively, the toothing 261 on the linear guide 231 and/or the counter-toothing on the tooth anchor 262 can be dispensed with, and a locking of the lifting unit alone can be implemented via static friction. In this case, it is also conceivable to attach the tooth anchor 262 alternatively or additionally to one or more linear actuators 230.

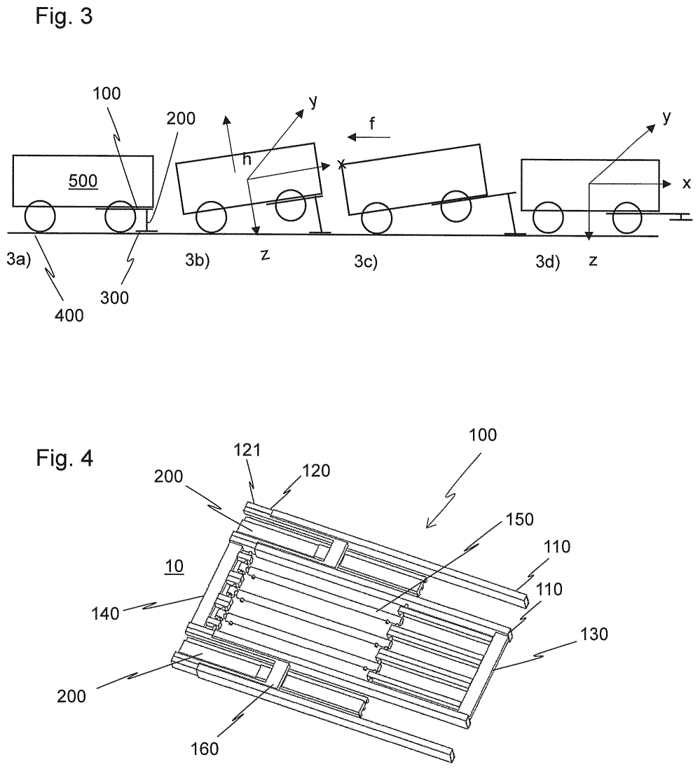

An exemplary movement course for the transportation of the vehicle 500, if said vehicle has become stuck, for example, on an unpaved ground surface, is diagrammatically sketched in FIG. 3. First, the lifting units 200, more precisely the linear actuators 230 thereof, are activated, whereby the traction feet 300 are moved by translation in the direction of the ground surface 400. Here, the two traction feet 300 can either be deployed at the same speed, or else each traction foot 300 can be individually actuated by the operator or a connected open-loop and/or closed-loop control device with stored control electronics, in order to adjust the respective lifting path to the constitution of the ground surface 400. The vehicle 500 is in the lowered vehicle position and rests completely on the ground surface 400 (position 3a). The lifting unit 200 with the linear actuators 230 arranged between the lifting support 211 and the traction foot 300 is here indicated purely diagrammatically and it can be designed in any embodiment, in particular in any embodiment described above or below. As soon as the traction feet 300 rest on the ground surface 400 and the lifting units 200 are deployed further, they start to lift the vehicle 500 in a lifting direction h via the guide rods 120 which are supported on the inner walls or contact and/or sliding surfaces of the guide rails 110 into unilateral or partially lifted vehicle position. The lifting direction h here always extends translationally and parallel to the vehicle vertical axis z (position 3b). During the lifting, it can be advantageous to retain the vehicle 500 in a horizontal orientation with respect to the vehicle transverse direction y in order to reduce the risk of tipping over. For this reason, the linear actuators 230 which are part of the two traction feet 300 can be separately actuated by the operator. Alternatively, a sensor system can also be provided as component of the lifting device 10, which automatically orients the vehicle 500 via a control electronics during the lifting. After the vehicle 500 has been lifted, the support device 100 is deployed, in that the linear rail actuators 150 are activated by the operator or the open-loop and/or closed-loop control device, whereby the guide rods 120 are shifted out of the guide rails 110. Due to the traction profile 310, sufficient friction is present between the ground surface 400 and the traction feet 300, so that the latter cannot be moved relative to the ground surface 400. Instead, the vehicle 500 is moved in a transportation direction f by a desired length corresponding to the length by which the guide rods 120 are deployed out of the guide rails 110 (position 3c, FIG. 2). Preferably, the wheels, chains and other drive means of the vehicle 500 still resting on the ground surface 400 roll on said ground surface, whereby the force expenditure for the transportation of the vehicle 500 decreases. Finally, the vehicle 500 is first lowered again by retracting the lifting unit 200 (position 3d), and the lifting device 10 is transferred into its completely retracted position (FIG. 1) by retraction of the support structure 100 by means of the linear rail actuators 150.

The described process can be repeated as many times as desired in order to negotiate the desired distance. By reversing the movement course, the transportation direction f can also be reversed. Alternatively, it is also conceivable to design the vehicle with lifting units on both longitudinal sides or transverse sides, whereby said vehicle can be transferred into a completely lifted vehicle position. In order to establish maximum friction between traction foot 300 and ground surface 400, it is appropriate to position the lifting units 200 in the vicinity of or as much as possible under the center of gravity of the vehicle.

FIG. 4 shows a diagrammatic perspective representation of a second exemplary embodiment of the lifting device 10 according to the invention, in which in each case one lifting unit 200 is arranged between every two adjacent guide rails 110. Compared to the embodiment described in FIGS. 1 and 2, the variant shown here consequently differs in that the lifting device 10 overall comprises four guide rails 110 oriented parallel to one another each having guide rods 120 guided therein. The lifting unit 200 arranged between two adjacent guide rails 110 is indirectly connected via a flat U-shaped connection piece 160 to the guide rods 120, more precisely to the connection section 121 thereof. The U-shaped connection piece 160 is preferably attached on the side of the guide rods 120 facing the vehicle bottom, in order to make room for the accommodation of the lifting unit 200 under the guide rods 120. The overall extension of the U-shaped connection piece 160, which extends in vehicle vertical direction z, and of the lifting unit 200 attached thereto, should not exceed the overall extension of the support structure 100, so that this embodiment variant has a particularly low ground clearance requirement. In order to stabilize the guide rails 110 and the guide rods 120, the rail connection piece 130 and/or the rod connection piece 140 alternatively can also connect (differently from the way it is shown here) all the guide rails 110 and/or all the guide rods 120 to one another. Furthermore, in an alternative variant not shown here, the U-shaped connection piece 160 can also be connected to a longitudinal side of the two guide rods 120 according to the first embodiment according to FIG. 1 and extend the guide rods 120 in the manner of a fork. The two lifting units 200 are then each arranged inside the “fork” and in a plane with the support structure 100.

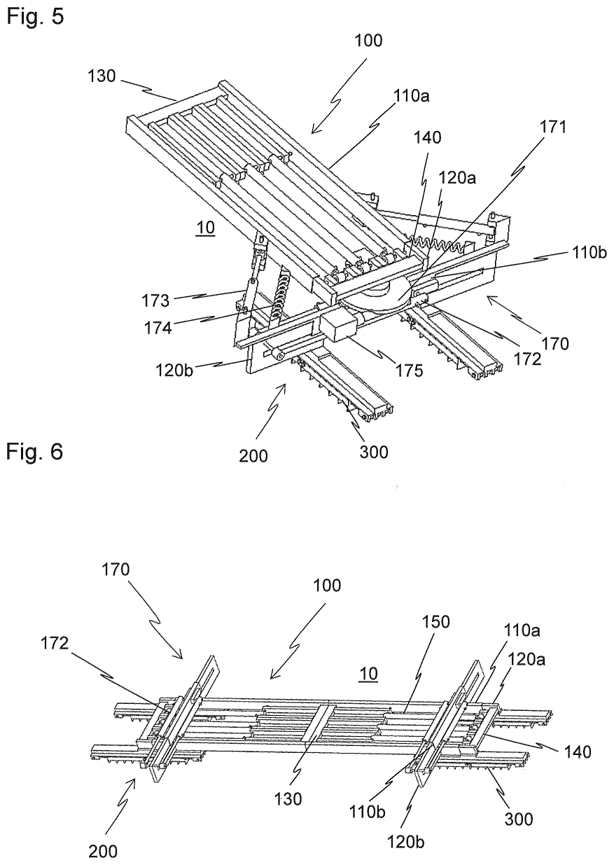

In FIG. 5, a diagrammatic perspective representation of a third exemplary embodiment of the lifting device 10 according to the invention is shown. This embodiment enables a transportation of the vehicle 500 not only in the vehicle longitudinal direction x but also in the vehicle transverse direction y. The support structure 100, as also in the previously described designs, is connected to the vehicle 500 via the longitudinal guide rails 110a oriented in the vehicle longitudinal direction x. In the longitudinal guide rails 110, longitudinal guide rods 120a are mounted and connected to with a rod connection piece 140. In addition, on the rod connection piece 140, a subsystem for the transverse movement 170 is articulated by means of a pivot bearing 171 which can rotate in an x-y plane. On the rotatable side of the pivot bearing 171, one or more transverse guide rails 110b are attached, in which a respective individual transverse guide rod 120b is mounted, which can be deployed or retracted from both sides of the transverse guide rail 110b. In this variant, two lifting units 200 are attached to the transverse guide rod 120b and oriented in the vehicle longitudinal direction x.

For the lateral deployment, i.e., in the vehicle transverse direction y, of the transverse guide rod 120b out of the transverse guide rails 110b, one or more transverse linear actuators 172 are supported with one end thereof on the transverse guide rail 110b and with the other end thereof on the transverse guide rod 120b and are designed, for example, as hydraulic cylinders, pneumatic cylinders, electrolinear units or according to another linear drive principle. By positioning of all the components necessary for deployment or retraction of the transverse guide rod 120b in the vehicle transverse direction y, any states of the longitudinal-side deployment can be combined independently of one another with any states of the transverse-side deployment. In the lifted vehicle position, during the transverse-side displacement of the vehicle 500, the subsystem for the transverse movement 170 must be rotatable with respect to the longitudinal guide rails 110a, in order to avoid material stresses which otherwise occur and which could lead possibly to destruction of components. In order to ensure that a rotation angle of the support structure 100 with respect to the subsystem for the transverse movement 170 returns to its starting state after the vehicle 500 has been transported, it is possible, for example, to provide pivoting linear actuators 173 and/or pivot springs 174 designed as traction-thrust springs and/or a pivot motor 175 indirectly or directly connected as rotating motor to the pivot bearing 171. In the representation, all three variants are shown purely as examples, wherein, in the practical implementation, only one of the variants should be used. In the embodiment shown according to FIG. 5, the subsystem for the transverse movement 170 is indirectly connected via the support structure 100 to the vehicle 500. However, it is also conceivable to connect the subsystem for the transverse movement 170 directly to the vehicle 500 and to connect the support structure 100 indirectly via the subsystem for the transverse movement 170 (as represented in FIG. 6).

FIG. 6 shows a diagrammatic perspective representation of a fourth exemplary embodiment of the lifting device 10 according to the invention, having a total of four lifting units 200 which are distributed for the complete lifting of the vehicle 500 over the two longitudinal sides of the vehicle 500. In addition, on the two longitudinal sides of the vehicle 500, a respective subsystem for the transverse movement 170 is also provided, so that the vehicle 500, in a completely lifted vehicle position, can be moved both in a vehicle longitudinal direction x and also in a vehicle transverse direction y. In principle, a lateral transportation occurs, i.e., in vehicle transverse direction y according to the embodiment variant described previously based on FIG. 5. However, based on the fact that the vehicle 500 is in a completely lifted vehicle position, an angle compensation between the support structure 100 and the subsystem for the transverse movement 170 is not necessary, and therefore the corresponding components such as pivot bearing 171, etc., can be dispensed with.

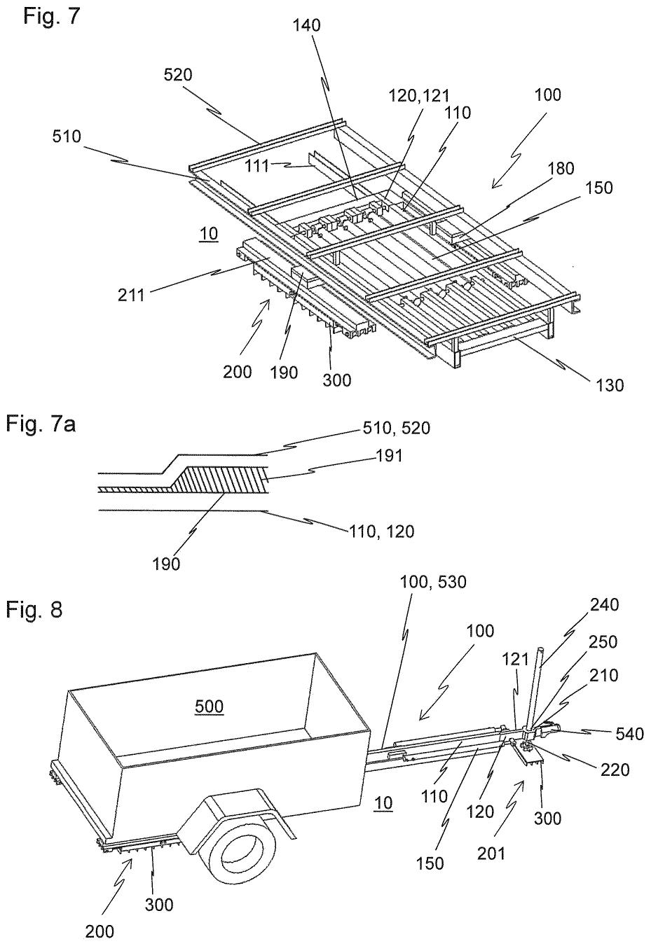

A diagrammatic perspective representation of a fifth exemplary embodiment of the lifting device 10 according to the invention can be obtained from FIG. 7. Here, the support structure 100 is attached to longitudinal members 510 and cross members 520 of the vehicle 500 itself, whereby the carrying capacity of the vehicle itself is exploited, so that the support structure 100 can correspondingly be designed to be smaller and lighter. For example, the cross-sectional area of both the guide rails 110 and also of the guide rods 120 can be selected to be smaller. For example, from the representation, a support structure can be obtained, as is used in some vehicle types such as, for example, trucks or all-terrain vehicles. In this embodiment, for example, the guide rails 110 are directly connected to the support structure, in particular to the cross members 520 of the vehicle 500. Two lifting units 200 are each arranged laterally, parallel to the guide rails 110, wherein the respective lifting supports 211 thereof are connected via L-shaped connection pieces 180 to the guide rods 120 guided in the guide rails 110. Via sliding elements 190, the lifting units 200 slide during the deployment or retraction of the support structure 100, each in contact along the longitudinal members 510 of the vehicle 500, and they are supported on said longitudinal members, whereby the weight of the vehicle 500 in the lifted vehicle position rests on the support structure itself of the vehicle. The side of the longitudinal member 510 facing the ground surface is thus used as supporting and/or sliding surface, here indirectly via the lifting support 211 of the lifting units 200, for the guide rods 120. The sliding elements 190 include a material which, in combination with its friction partner, has a low friction and wear value. Advantageously, on the longitudinal members 510 and/or cross members 520 of the vehicle 500, an adapter structure 191 can be attached (see FIG. 7a), of which the side facing the sliding elements 190 has a straight and flat sliding surface, and the other sides of which are supported on the structure of the vehicle underbody and/or its supporting structure. Naturally, it is also conceivable to connect the sliding elements 190 firmly to the longitudinal members 510 and/or any adapter structure 191.

Since the supporting structure of the vehicle 500 almost completely absorbs forces and moments transmitted by the lifting units 200, the guide rails 110 and the guide rods 120, in the case of identical deployment path or displacement of the vehicle 500, can be designed to be shorter than in the previously described embodiments. However, in order to prevent, in the deployed state of the guide rods 120 out of the guide rails 110 and with simultaneously lowered vehicle 500 resting on the ground surface 400, the guide rods 120 from tipping over laterally in transverse direction y and/or downward in the direction of the ground surface 400, the guide rods 120 each comprise rail extensions 111 which are open upward in the direction of the vehicle underbody. The upper side of the rail extensions 111, directed in the direction of the vehicle underbody, has no guiding and/or supporting function; instead the lifting supports 211 are supported on the lower sides of the longitudinal member 510 of the vehicle 500, which face the ground surface 400.

From FIG. 7a a diagrammatic partial section of an embodiment variant of an adapter structure 191 can be obtained. The adapter structure 191 is here arranged, in an example, between the longitudinal members 510 and/or cross members 520 of the vehicle 500 and between the guide rails 110 and/or the guide rods 120. The side of the adapter structure 191 associated with the vehicle 500 advantageously has a design which is complementary (in the present example step-like) to the longitudinal members 510 and/or cross members 520. Optionally, as already previously described, sliding elements 190 (see FIG. 7) can be provided in order to reduce the friction coefficients.

In FIG. 8, a diagrammatic perspective representation of a sixth exemplary embodiment of the lifting device 10 according to the invention, which is attached to a vehicle 500, here a tractor/trailer combination, is represented. Naturally, all the other previously described embodiments can be connected without change to a trailer on its own. In principle, a trailer, due to the additional weight and since the trailer does not have a separate drive axle, decreases the maneuverability of a vehicle 500 which in the present case is designed as a combination of a tractor and one or more trailers. However, the embodiment shown in this representation exploits some peculiarities of the trailer. Thus, the drawbar 530 of the trailer, as support structure 100, can be designed to be extendible and correspondingly comprises one or more guide rails 110 (in the present representation, one guide rail), with guide rods 120 mounted therein. The connection section 121 of the guide rod 120 is indirectly connected to the traction vehicle via the trailer coupling 540 and/or it is itself designed as trailer coupling 540. The guide rail 110 is connected to the trailer itself, so that a relative movement caused by one or more linear actuators 150, in this case two linear actuators, between guide rail 110 and guide rod 120 leads to a lengthening of the drawbar 530. Two lifting units 200 oriented parallel to the vehicle longitudinal direction x, according to the previously described embodiment variants, are directly and firmly attached to the trailer, preferably in the vicinity of its center of gravity, i.e., the lifting units are indirectly connected via the trailer to the guide rail 110 and can be deployed together with the trailer via the extendible drawbar 530 relative to the tractor in the vehicle longitudinal direction x. An additional lifting unit 200, oriented parallel to the vehicle transverse direction y, is arranged on the connection section 121 of the guide rod 120 still before the trailer coupling 540. The transversely oriented lifting unit 200 is designed as vertical lifting unit 201 with a lifting linear actuator 240 which is preferably arranged orthogonally to the guide rods 120 and held by or supported on a corresponding recess 250 in the connection section 121 of the guide rod 120. The lifting linear actuator 240 can be designed, for example, as a hydraulic cylinder or pneumatic cylinder or electrolifting unit, etc., and it lifts the connection section 121 of the guide rod 120 in its deployment direction. In other words, the lifting linear actuator 240 itself is always oriented along the lifting direction h.

In order to transfer a self-driving traction vehicle back into a position allowing maneuverability, according to the sixth embodiment in FIG. 8, the trailer is first lifted by means of the longitudinally oriented lifting units 200. Subsequently, via the linear actuators 150, the guide rod 120, connected to the tractor via the trailer coupling, is moved out of the guide rail 110, wherein the tractor is moved in the vehicle longitudinal direction x, while the trailer in the lifted state remains fixed relative to the ground surface 400. After the tractor has been displaced in the vehicle longitudinal direction x, the trailer is lowered again by retraction of the lifting units 200, and the guide rod 110 is reinserted into the guide rail 120, whereby, in the ideal case, the trailer is pulled at the same time in the direction of the tractor. If the trailer itself is stuck immobilized in the ground surface 400, the transversely oriented lifting unit 200 can additionally be activated, whereby its traction foot 300 is supported on the ground surface 400, so that the stability of the tractor is increased while the trailer is pulled.

The lifting units 200 described in the different embodiments can each also be designed as a more simply constructed vertical lifting unit, if the installation space available allows this. The use of other lifting units 200 known from the prior art, such as, for example, a scissor-type jack, is naturally also conceivable. In the following paragraphs, different exemplary designs of a traction foot 300 are explained in greater detail. Each of the explained designs can be combined both with a lifting unit 200 according to one of embodiment examples 1 to 5 and also with a lifting unit 200, designed as a vertical lifting unit according to embodiment example 6 or even with another lifting unit 200 known from the prior art, such as, for example, a scissor-type jack.

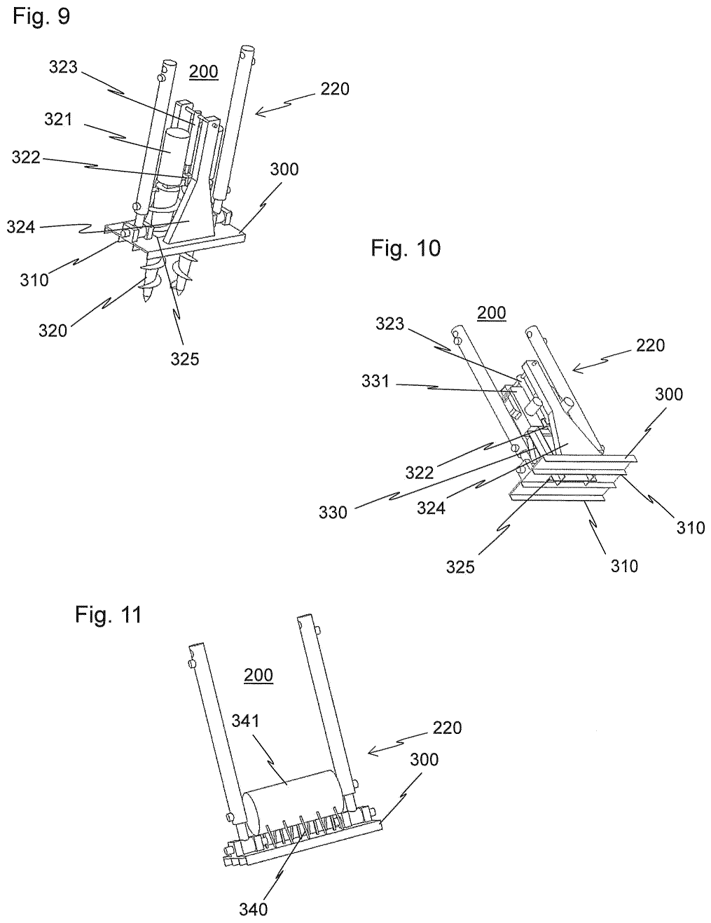

A diagrammatic perspective representation of a first exemplary embodiment of a traction foot 300, which is articulated to a lower section 220 of a lifting unit 200 designed as vertical lifting unit, can be obtained from FIG. 9. Thus, the traction foot 300 can be designed with one or more ground drills, here two ground drills 320, which are driven via connected drill motors 321. The drill motors 321 in turn are attached to a holding device 322 and connected thereby to one another. The holding device 322 is attached on an end of a contact pressure actuator 323 which can be designed as hydraulic cylinder, pneumatic cylinder or electrolifting unit, etc. The other end of the contact pressure actuator 323 is supported on holding elements 324 which in turn are connected to the traction foot 300. Via the contact pressure actuator 323, the required contact pressure is generated during the rotation of the ground drills 320, so that, for the purpose of maximizing the traction between traction foot 300 and ground surface 400, said ground drills are drilled into the latter. The traction foot 300 comprises a passage opening 325 for the passage of the ground drill 320. By a combination of ground drills 320 and traction profile 310, a particularly high stability of the lifting unit 200 on almost any ground surface 400 can be achieved.

A second exemplary embodiment of a traction foot 300 is shown in FIG. 10 in a diagrammatic perspective representation. In principle, the second embodiment of the traction foot 300 is constructed similarly to the previously described first embodiment. However, instead of the ground drill 320, hammering traction plates 330 are here attached to the holding device 322. Preferably, the hammering traction plates 330 are driven by hammering actuators 331. The hammering actuators 331 act in the manner of electrohammers or hydraulic hammers or pressurized air hammers known from the prior art and drive the traction plates 330 out into the ground surface 400 in order to increase the traction of the traction foot 300 via the action of the traction profile 310.

Finally, from FIG. 11, a diagrammatic perspective representation of a third exemplary embodiment of a traction foot 300 on a lower section 220 of a lifting unit 200 can be obtained. The embodiment shown here is particularly suitable for soft ground surfaces 400, in that a traction foot 300 is designed with so-called cryonozzles 340, the outlet openings of which are provided on the side of the traction foot 300 facing the ground surface 400. If desired, if the traction foot 300 rests on the ground surface 400, the outflow of the cryogen from the outlet openings can be started by the operator. Due to the penetration of the cryogen into the soft ground surface 400, the latter is solidified or even frozen, whereby the traction foot 300 has a better foothold. The cryogen can be stored in a cryotank 341 attached to the traction foot 300 or can be supplied from another reservoir via pipe and/or hose connection to the cryonozzles 340. As cryogen, for example, cold and/or liquefied air, other cold and/or liquefied gases, solid carbon dioxide as well as other cryogens known from the prior art are suitable.

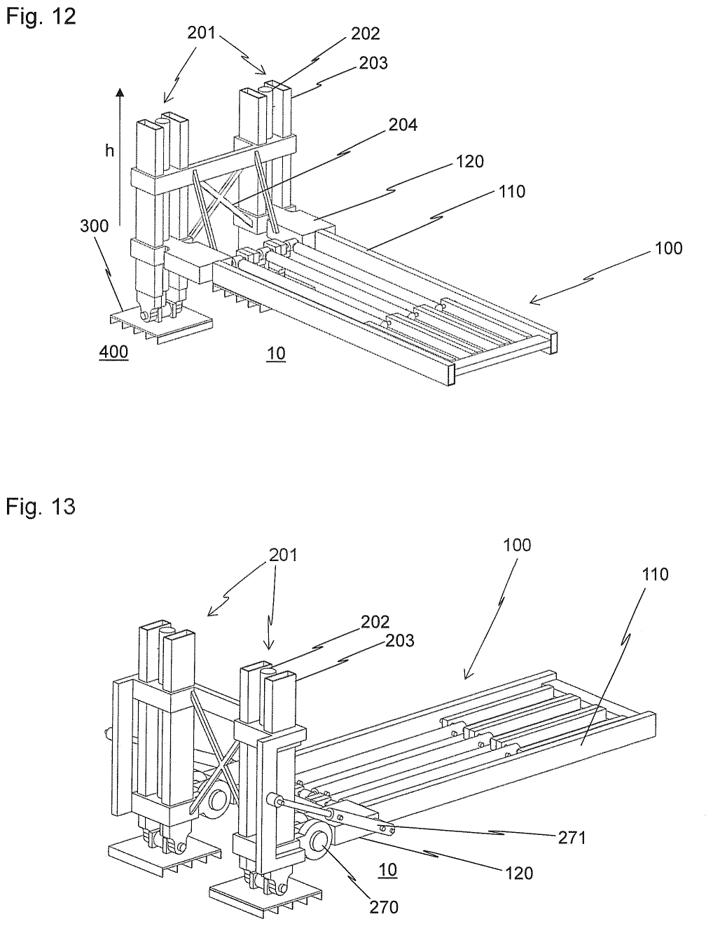

From FIGS. 12 to 15, respective diagrammatic perspective representations of different exemplary designs of the lifting device 10 can be obtained, in which the lifting units 200 are each designed as vertical lifting units 201 oriented orthogonally or nearly orthogonally to the support structure 100 and pointing in the operating position in the direction of the ground surface 400.

Thus, FIG. 12 shows a lifting device 10 having two vertical lifting units 201 each comprising a lifting cylinder 202 which is flanked by two lifting guides 203 extending parallel thereto. The lifting guides 203, together with the lifting cylinder 202, can deploy preferably perpendicularly opposite the lifting direction h in the direction of the ground surface 400 and absorb the bending moments occurring during the lifting and displacement of the vehicle 500. The vertical lifting units 201 are each indirectly or directly connected via the first end thereof to the support structure 100, for example, the guide rods 120, and, at the second end thereof, they comprise a respective traction foot 300 supported on the ground surface 400. Between the two vertical lifting units 201 and/or between a respective vertical lifting unit 201 and the support structure 100, stiffening struts 204, here running diagonally, can be arranged, in order to absorb the forces occurring during the transportation of the vehicle 500. The positioning of the stiffening struts 204 is represented here as an example; depending on the concrete design of the lifting device 10, the stiffening struts 204 can also be provided in any other positions for optimal force absorption. As desired, the support structure 100 can be attached on the underbody, on the loading surface, on the vehicle roof, on the engine hood, in the storage space or in other suitable positions of a vehicle 500, which is not represented here. The vertical lifting units 201 are preferably arranged on the rear, on the front or laterally on the vehicle 500.

The lifting device 10 represented in FIG. 13 substantially corresponds to the previously described embodiment according to FIG. 12. In addition, between a respective vertical lifting unit 201 and the support structure 100 or the guide rods 120, a respective articulation 270 is arranged. By means of respective pivot cylinders 271, the first end of which is attached indirectly or directly to the support structure 100, in particular to the guide rods 120, and the second end of which is indirectly or directly connected to the vertical lifting unit 201, the vertical lifting units can be pivoted or rotated about the respective articulation axis between a transport position and the operating position shown here. The articulation axis is here directed orthogonally to the course of the guide rods 120 and the guide rails 110, so that the vertical lifting units 201 in the transport position are oriented parallel thereto and in the operating position orthogonally thereto.

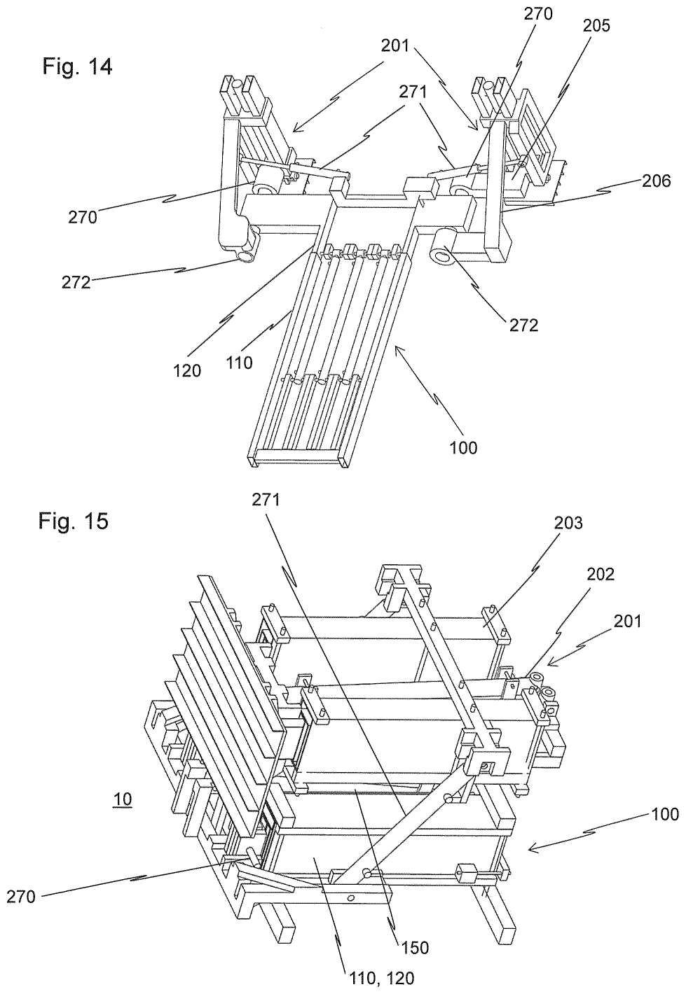

An alternative embodiment of the lifting device 10, in which the articulation axes of two articulations 270 are oriented parallel and the pivoting cylinders 271 are oriented orthogonally to the guide rods 120 and the guide rails 110, can be obtained from FIG. 14 in a pivoted out operating position. So that the vertical lifting units 201 do not collide with one another during the pivoting in or during the rotation about the articulation axes, it is advantageous to design one vertical lifting unit or both vertical lifting units 201 with an extension 205 accommodating the respective articulation 270. When one extension 205 is used for each vertical lifting unit 201, said extensions should have mutually differing lengths. In the pivoted-in transport position, not shown here, the vertical lifting units 201 are then arranged correspondingly one above the other. Alternatively, it is also conceivable to arrange the vertical lifting units 201 mutually offset in the longitudinal direction of the guide rods 120. For the absorption of bending moments, the vertical lifting units 201 can have a respective stiffener 206 which is then connected to the support structure 100 via its own second articulation 272, arranged in alignment with the articulation 270, so that pivoting and/or rotation about the same articulation axis is/are possible.

Alternatively, but not represented in the figures, an additional embodiment is conceivable, in which the respective vertical lifting units 201 are mounted so that they can be pivoted and/or rotated about an articulation axis of respective articulations 270, which is oriented orthogonally to the guide rods 120 and which protrudes from a plane predetermined by the support structure 100 or “stands” perpendicularly on the guide rods 120.

In all the previously described embodiments of the lifting device 10, it can be advantageous to telescopically design one or more components of the lifting units 200, of the vertical lifting units 201 and/or of the support structure 100, so that the lifting device 10, in particular the lifting units 200 and/or the vertical lifting units 201 can (also) be linearly moved between a compact or space-saving transport position and an operating position.

Such an exemplary embodiment, in which the lifting device 10 is shown in a pivoted-in and retracted transport position, can be obtained from FIG. 15. The here single vertical lifting unit 201 is pivotably and/or rotatably connected via articulations 270 to the guide rods 120 of the support structure 100. The lifting cylinder 202 and the lifting guides 203 of the vertical lifting unit 201 as well as the guide rods 120, the guide rails 110 and the linear rail actuators 150 of the support structure 100 are moreover telescopically designed, i.e., they can be coaxially retracted or deployed, whereby, for example, the guide rods 120 at the same time also can perform the function of a guide rail 110. If necessary, the pivoting cylinders 271 can also be telescopically designed. The embodiment shown enables a particularly space-saving arrangement of the lifting device 10 in the transport position shown, in order to arrange or install the lifting device 10 also in particularly tight installation spaces, for example, in the trunk space of a passenger car. In principle, for all the previously described embodiments, the embodiment-specific features can be combined with one another if technically feasible. For example, each of the described embodiments can be implemented with two or four or another desired number of lifting units 200, 201. The different design of the exemplary traction feet 300 or lifting units 200, 201 can be combined with any embodiments. Advantageously, the positioning of the lifting units 200, 201 with respect to the support structure 100 and/or the attachment of the support structure 100 on the vehicle 500 can be adapted to the respective space specifications of the vehicle 500.

### LIST OF REFERENCE NUMERALS

10 Lifting device
100 Support structure
110 Guide rail
110a Longitudinal guide rail
110b Transverse guide rail
111 Rail extensions
120 Guide rod
121 Connection section of the guide rods
120a Longitudinal guide rod
120b Transverse guide rod
130 Rail connection piece
140 Rod connection piece
150 Linear rail actuator
160 U-shaped connection piece
170 Subsystem for transverse movement
171 Pivot bearing
172 Transverse linear actuators
173 Pivoting linear actuators
174 Pivot springs
175 Pivot motor
180 L-shaped connection piece
190 Sliding element
191 Adapter structure
200 Lifting unit
201 Vertical lifting unit
202 Lifting cylinder
203 Lifting guide
204 Stiffening struts
205 Extension
206 Stiffener
210 Upper section of the lifting unit
211 Lifting support
220 Lower section of the lifting unit
230 Linear actuator
231 Linear guide
240 Lifting linear actuator
250 Recess
260 Stopping means
261 Toothing
262 Tooth anchor
263 Actuator
270 Articulation
271 Pivot cylinder
272 Second articulation
300 Traction foot
310 Traction profile
320 Ground drill
321 Drill motor
322 Holding device
323 Contact pressure actuator
324 Holding element
325 Passage opening
330 Hammering traction plates
331 Hammering actuator
340 Cryonozzles
341 Cryotank
400 Ground surface
500 Vehicle
510 Longitudinal member
520 Cross member
530 Drawbar
540 Trailer coupling
f Transportation direction
h Lifting direction
x Vehicle longitudinal direction
y Vehicle transverse direction
z Vehicle vertical axis

1. A lifting device (10) for the transportation of a vehicle (500) and comprising
a support structure (100) which is suitable for releasable or firm connection to the vehicle (500), and
at least one lifting unit (200, 201) which is provided to lift the vehicle (500) in a lifting direction (h) from a lowered vehicle position in which the vehicle (500) rests on a ground surface (400) into a completely or partially lifted vehicle position,
characterized in that
the support structure (100) comprises one or more guide rails (110) as well as one or more guide rods (120) which are guided linearly in the guide rails (110), wherein either the guide rails (110) are indirectly or directly connected to the vehicle (500) and the guide rods (120) are indirectly or directly connected to at least one lifting unit (200, 201) or alternatively the guide rods (120) are indirectly or directly connected to the vehicle (500) and the guide rails (110) are indirectly or directly connected to at least one lifting unit (200, 201), so that,
in the lifted vehicle position, either the guide rails (110) or alternatively the guide rods (120), together with the vehicle (500), can be moved linearly relative to the ground surface (400) and
in the lowered vehicle position, either the guide rods (120) or alternatively the guide rails (110), together with the at least one lifting unit (200, 201), can be moved linearly relative to the ground surface.

2. The lifting device (10) according to claim 1,
characterized in that
one or more guide rails (110) and one or more guide rods (120) are oriented parallel to the vehicle longitudinal direction (x) or parallel to the vehicle transverse direction (y), so that the guide rods (120) are guided in the guide rails (110) linearly in the vehicle longitudinal direction (x) or linearly in the vehicle transverse direction (y).

3. The lifting device (10) according to claim 1 or 2,
characterized in that
the support structure (100) comprises at least two guide rails (110) oriented parallel to one another, each having guide rods (120) guided therein, wherein the guide rails (110) are connected to one another via a rail connection piece (130) and the guide rods (120) are connected to one another via a rod connection piece (140) for the formation of a linearly retractable frame structure, wherein the rail connection piece (130) can be moved relative to the rod connection piece (140).

4. The lifting device (10) according to claim 1,
characterized in that
the guide rods (120) are arranged within the guide rails (110) and at least two inner walls of the guide rails (110) are configured as supporting or sliding surfaces on which the guide rods (120) are supported when subjected to forces.

5. The lifting device (10) according to claim 3,
characterized in that,
with respect to the vehicle longitudinal direction (x), at least one lifting unit (200, 201) is oriented longitudinally with respect to the support structure (100) and is connected to one or more guide rods (120), so that the support structure (100) and the at least one lifting unit (200, 201) are arranged in a common plane, wherein the lifting unit (200, 201) extends either between mutually adjacent guide rails (110) or is arranged longitudinally with respect to one or more guide rods (120).

6. The lifting device (10) according to claim 5,
characterized in that
one or more lifting units (200, 201) are exclusively arranged on a vehicle longitudinal side or vehicle transverse side, wherein the vehicle (500) can be moved along the lifting direction (h) from the lowered vehicle position into an only partially lifted vehicle position.

7. The lifting device (10) according to claim 5,
characterized in that
the connection of the at least one lifting unit (200, 201) to one or more guide rods (120) or to one or more guide rails (110) is fixed, so that the lifting direction (h) is always oriented substantially parallel to the vehicle vertical axis (z).

8. The lifting device (10) according to claim 3,
characterized in that
the connection of the at least one lifting unit (200, 201) to one or more guide rods (120) or to one or more guide rails (110) is implemented by means of an articulation (270), so that the at least one lifting unit (200, 201) can be pivoted or rotated between a transport position and an operating position.

9. The lifting device (10) according to claim 1,
characterized in that
one or more components of the at least one lifting unit (200, 201) or of the support structure (100) are telescopically configured so that the lifting unit (200, 201) can be moved linearly between a transport position and an operating position or the vehicle (500) can be moved in the lifted vehicle position linearly relative to the ground surface (400).

10. The lifting device (10) according to claim 1,
characterized in that
the at least one lifting unit (200, 201) has a stopping means (260) which stops at least one lifting unit (200, 201) in a retracted, completely deployed or partially deployed position.

11. The lifting device (10) according to claim 3,
characterized in that
the support structure (100) is configured for indirect or direct attachment to one or more longitudinal members (510) or cross members (520) of the vehicle underbody of the vehicle (500), wherein at least one wall of the longitudinal member (510) or cross member (520) connected to the support structure (100) is a supporting or sliding surface on which the guide rods (120) of the support structure (100) are supported when subjected to forces.

12. A vehicle (500) having a lifting device (10) according to claim 1,
characterized in that
the one or more guide rails (110) of the support structure (100) are indirectly or directly connected firmly or releasably to the motor vehicle (500), by an attachment on the vehicle underbody or on the vehicle roof or to on a vehicle loading surface or on the vehicle frame or on the vehicle body takes place.

13. The vehicle (500) according to claim 12,
characterized in that
the one or more guide rails (110) of the support structure (100) are attached to one or more longitudinal members (510) or cross members (520) of the vehicle underbody of the vehicle (500), wherein at least one wall of the longitudinal member (510) or cross member (520) connected to the support structure (100) is designed as a supporting or sliding structure on which the guide rods (120) of the support structure (100) are supported when subjected to forces.

14. The vehicle (500) according to claim 12,
characterized in that
the at least one lifting unit (200, 201) is arranged in a transport position in a storage space or on a loading surface or on the roof or on the hood or on the trunk lid of the vehicle (500) or on the vehicle front or on the vehicle rear or laterally on the vehicle (500) and can be moved or pivoted by means of the support structure (100) between the transport position and an operating position for the transportation of the vehicle (500).

15. A method for the transportation of a vehicle (500) by means of a lifting device (10) according to claim 1, wherein the vehicle (500)
is lifted in a lifting direction (h) from a lowered vehicle position, in which the vehicle (500) rests on a ground surface (400), into a completely or partially lifted vehicle position by means of at least one lifting unit (200, 201) of the lifting device (10),
is displaced relative to the ground surface (400) in the lifted vehicle position by means of mutually movable guide rails (110) and guide rods (120) of a support structure (100) of the lifting device (10) and
is lowered from the completely or partially lifted vehicle position into the lowered vehicle position by means of the at least one lifting unit (200, 201) of the lifting device (10).
